(19) United States
(12) Patent Application Publication
(10) Pub. No.: US 2025/0069085 A1
(43) Pub. Date: Feb. 27, 2025

(54) COMPUTERIZED SYSTEMS AND METHODS FOR ADAPTIVE DEVICE MANAGEMENT

(71) Applicant: PLUME DESIGN, INC., Palo Alto, CA (US)

(72) Inventors: Alexey GADALIN, Kirkland, WA (US); Derek LOWNSBROUGH, Kelowna (CA); Ruk SUNDARAMURTHY, Petaluma, CA (US); Yassine FANANE, Portland, OR (US); Andriy LYASHCHENKO, Ridding, CA (US)

(21) Appl. No.: 18/453,532

(22) Filed: Aug. 22, 2023

(51) Int. Cl. G06Q 30/012; G06F 3/0484; H04W 8/18

(52) U.S. Cl. CPC G06Q 30/012; G06F 3/0484; H04W 8/183

(57) ABSTRACT

Disclosed are systems and methods that provide a computerized device management framework that deterministically identifies and applies device warranty policies that manage how devices can be properly used, as well as the real-world and digital circumstances of such usage respective to approved activities subject to a warranty policy review. The disclosed framework can automatically detect a device's connection to a network (e.g., a Wi-Fi network), and based on information related to the device and the established connection, inter alia, determine which type of warranty policy to enact for the device and/or user of the device. The policy determination can effectuate the type of policy, term and/or conditions and exclusions that dictate how the device and/or activity related to the device are covered under the policy, and the real-world/digital manners for which the device can be utilized.

### FIELD OF THE DISCLOSURE

The present disclosure is generally related to device management, and more particularly, to a decision intelligence (DI)-based computerized framework for deterministically managing and/or controlling a device based on determined analytics and applied management control via a device and/or network provider.

### BACKGROUND

A device warranty can enable the processing of warranty claims as well as ensure that users (or customers, used interchangeably) receive prompt and effective claim determinations. Conventional mechanisms for applying warranty policies, identifying which policies to select and determining whether they are satisfied via device usage are static in nature, in that they are entirely based on manual control and override, typically by an underwriter (or policy adjuster) respective to the manner of such claim's submission.

### SUMMARY OF THE DISCLOSURE

Accordingly, the disclosed systems and methods provide a novel computerized framework that adaptively selects and applies warranty policies to devices based on a variety of dynamically determined and monitored factors, which can include, but are not limited to, events related to the device, user behavior respective to the device, location of alleged claims and network/usage metrics of the device, among other known or to be known factors.

According to some embodiments, as discussed herein, the disclosed framework can automatically detect a device's connection to a network (e.g., a Wi-Fi network), and based on information related to the device and the established connection, inter alia, determine which type of warranty policy to enact for the device and/or user of the device. The policy determination can effectuate the type of policy, term and/or conditions and exclusions that dictate how the device and/or activity related to the device are covered under the policy. Accordingly, a policy can be automatically selected and applied to the device (or a device's user), which covers its usage both when it is connected to the network and when the device is connected to another network (or not connected to a network). In some embodiments, based on monitored or tracked usage of the device, the framework can enable a dynamic update or modification to the applied policy which can correlate to the real-time usage by the user of the device.

Accordingly, in some embodiments, the disclosed framework provides an agile and adaptive warranty management system that can integrate into a service provider or third party's point of sale and/or inventory management systems. The framework, therefore, can bolster how devices are managed, which can effectuate a reduction in resource expenditure by the service provider/third party in discerning whether device's are capable of being upgraded/replaced upon a claim being submitted. As provided herein, the disclosed framework can adaptively control and manage how claims are submitted, as well as auto-generate the details of such claim submission. The disclosed streamlined processing can improve how warranty claims are processed, as well as improve their accuracy and efficiency in a claim's determination. As such, as evidenced from the disclosure herein, existing drawbacks in a claim's submission respective to a warranty policy, as well as potential inaccuracies and delays in an underwriter's review can be avoided via the dynamic and automated mechanisms of the disclosed warranty management framework.

According to some embodiments, a method is disclosed for a DI-based computerized framework for deterministically identifying and applying device warranty policies that manage how devices can be properly used, as well as the real-world and digital circumstances of such usage respective to approved activities subject to a warranty policy review.

In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for deterministically identifying and applying device warranty policies that manage how devices can be properly used, as well as the real-world and digital circumstances of such usage respective to approved activities subject to a warranty policy review.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 depicts an exemplary implementation of an architecture according to some embodiments of the present disclosure;

FIG. 5 depicts an exemplary implementation of an architecture according to some embodiments of the present disclosure; and

FIG. 6 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ different architectures or may be compliant or compatible with different protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

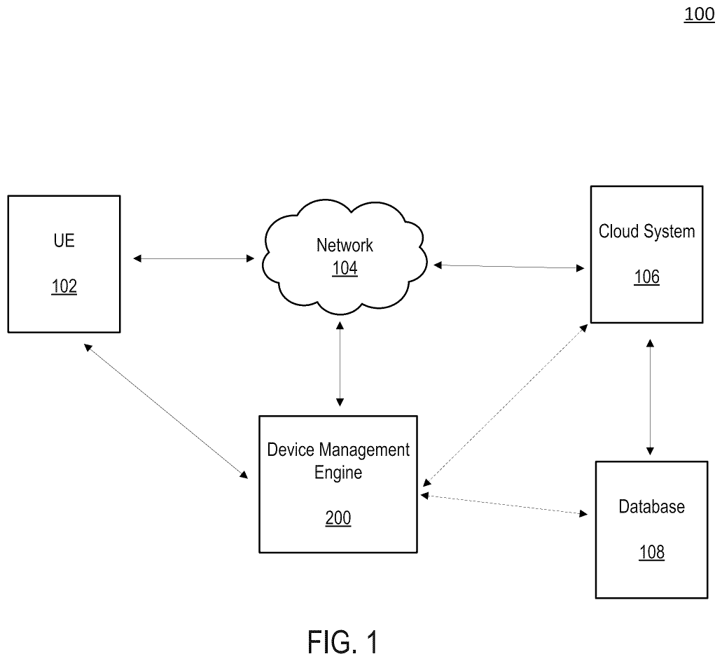

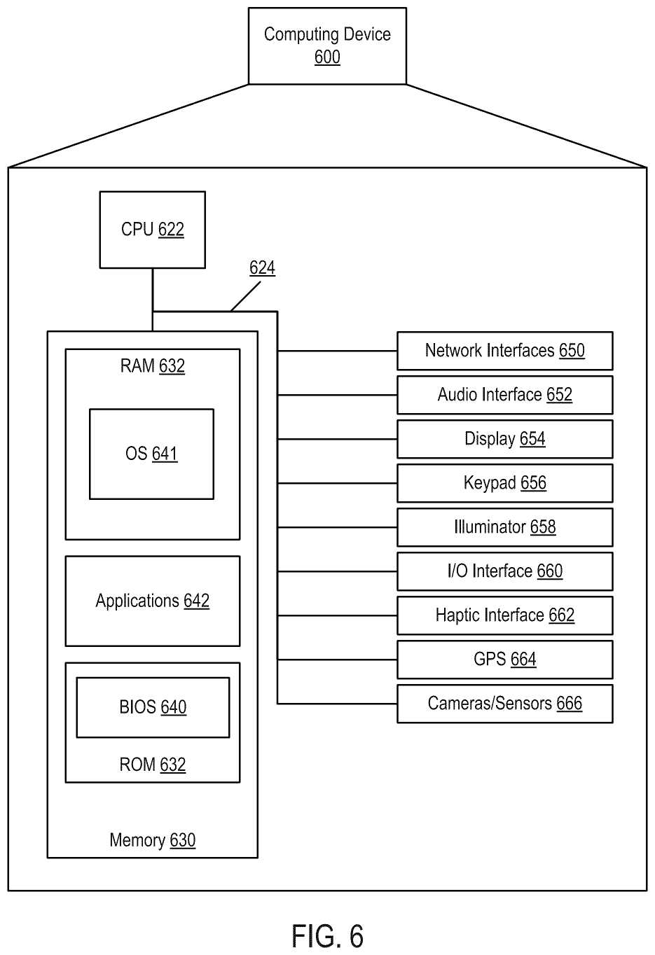

Certain embodiments and principles will be discussed in more detail with reference to the figures. With reference to FIG. 1, system 100 is depicted which includes user equipment (UE) 102 (e.g., a client device, as mentioned above and discussed below in relation to FIG. 6), network 104, cloud system 106, database 108 and device management engine 200. It should be understood that while system 100 is depicted as including such components, it should not be construed as limiting, as one of ordinary skill in the art would readily understand that varying numbers of UEs, access point devices, peripheral devices, cloud systems, databases and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, sensor, IoT device, autonomous machine, and any other device equipped with a cellular or wireless or wired transceiver.

In some embodiments, a peripheral device (not shown) can be connected to UE 102, and can be any type of peripheral device, such as, but not limited to, a wearable device (e.g., smart watch), printer, speaker, sensor, and the like. In some embodiments, a peripheral device can be any type of device that is connectable to UE 102 via any type of known or to be known pairing mechanism, including, but not limited to, WiFi, Bluetooth™, Bluetooth Low Energy (BLE), NFC, and the like. In some embodiments, a peripheral device can be another UE connected to or paired with UE 102.

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a smart home or network provider, which has associated network resources hosted on the internet or private network (e.g., network 104), which enables (via engine 200) the device management discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE 102 and the services and applications provided by cloud system 106 and/or device management engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

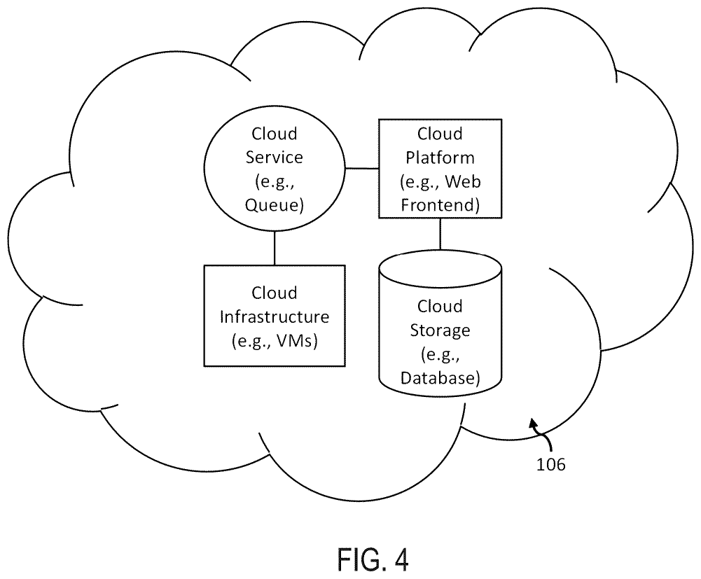

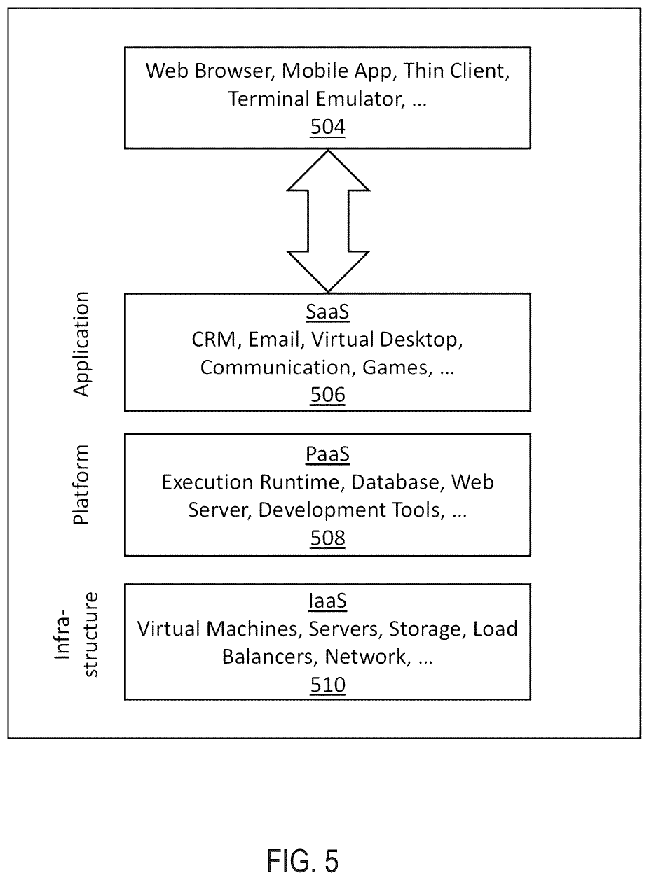

Turning to FIGS. 4 and 5, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure as a service (IaaS) 510, platform as a service (PaaS) 508, and/or software as a service (SaaS) 506 using a web browser, mobile app, thin client, terminal emulator or other endpoint 504. FIGS. 4 and 5 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

In some embodiments, database 108 can include a dataset of data and metadata associated with local and/or network information related to users, services, applications, content, content and/or service providers, third party websites and the like. As discussed herein, it should be understood that the data and metadata in the database 108 can be any type of information and type, whether known or to be known, without departing from the scope of the present disclosure. By way of a non-limiting example, as discussed in more detail below, the data can correspond to, but is not limited to, any type of content (e.g., text, web pages, images, video, and the like, for example), as well as, but not limited to, information associated with a user profile, user interests, user behavioral information, user attributes, user preferences, user demographic information, user location information (e.g., geographic information), user biographic information, and the like, or some combination thereof. In some embodiments, database 108 can further include user information, such as, but not limited to, identifier (ID), address, email address, geographic information, demographic information, social media information, behavioral patterns, real-world activity information (e.g., GPS data collected from a device of the user, for example), digital activity information (e.g., search and/or web history, for example), device or browser (e.g., consent) information (e.g., types of devices or browsers, and/or cookie settings on such browsers and/or user devices, for example), and the like, or some combination thereof.

In some embodiments, the data/metadata in database 108 can also include user device information, including, but not limited to, device identifying information, device capability information, voice/data carrier information, Internet Protocol (IP) address, applications installed or capable of being installed or executed on such device, and/or any, or some combination thereof. It should be understood that the data (and metadata) can be any type of information related to a user, a network, the content requested and/or interacted with by the user/device, a device, an application, a service provider, a content provider, whether known or to be known, without departing from the scope of the present disclosure.

Device management engine 200, as discussed above and further below in more detail, can include components for the disclosed functionality. According to some embodiments, device management engine 200 may be a special purpose machine or processor, and can be hosted by a device on network 104, within cloud system 106 and/or on UE 102. In some embodiments, engine 200 may be hosted by a server and/or set of servers associated with cloud system 106. For example, engine 200 may provide a device warranty management service, via the cloud system 106, which can monitor and control how device's operate under respectively applied warranty policies.

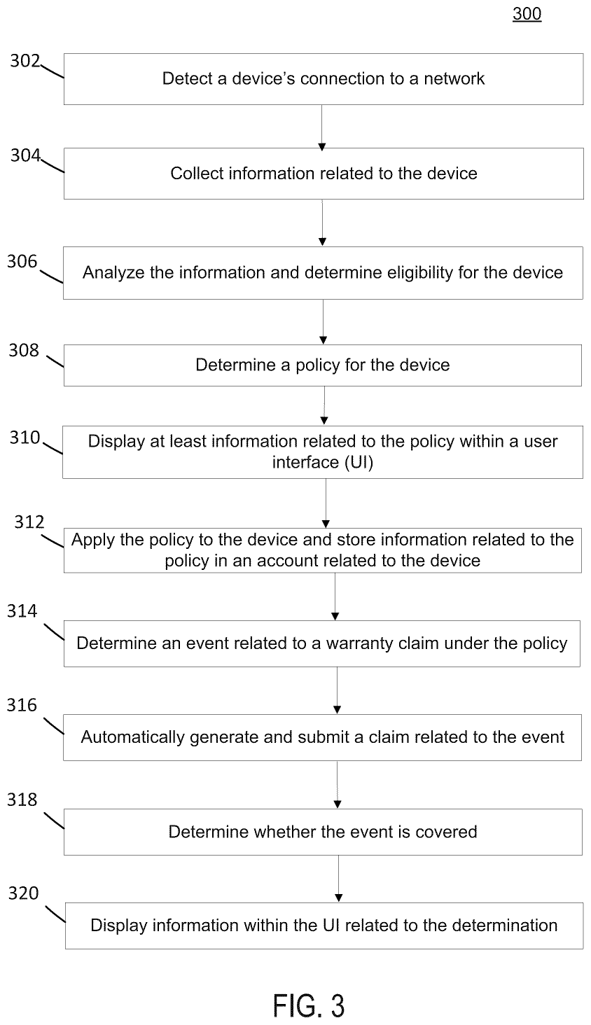

According to some embodiments, as discussed in more detail below, device management engine 200 may be configured to implement and/or control a plurality of services and/or microservices, where each of the plurality of services/microservices are configured to execute a plurality of workflows associated with performing the disclosed device management. Non-limiting embodiments of such workflows are provided below in relation to at least FIG. 3.

According to some embodiments, as discussed above, device management engine 200 may function as an application provided by cloud system 106. In some embodiments, engine 200 may function as an application installed on a server(s), network location and/or other type of network resource associated with system 106. In some embodiments, engine 200 may function as an application installed and/or executing on UE 102. In some embodiments, such application may be a web-based application accessed by UE 102 over network 104 from cloud system 106. In some embodiments, engine 200 may be configured and/or installed as an augmenting script, program or application (e.g., a plug-in or extension) to another application or program provided by cloud system 106 and/or executing on UE 102.

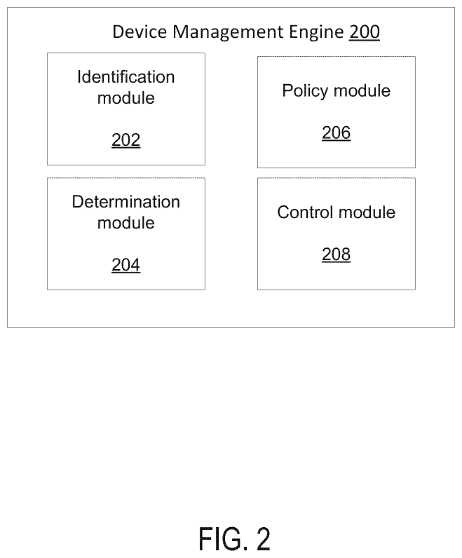

As illustrated in FIG. 2, according to some embodiments, device management engine 200 includes identification module 202, determination module 204, policy module 206 and control module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

Turning to FIG. 3, Process 300 provides non-limiting example embodiments for the disclosed device management framework. As discussed herein, the disclosed framework, via engine 200, can effectuate the identification and application of device warranty policies that manage how devices can be properly used, as well as the real-world and digital circumstances of such usage respective to approved activities subject to a warranty policy review. Accordingly, the framework can effectuate control of a device via, but not limited to, the type of policy, term and/or conditions and exclusions that dictate how the device and/or activity related to the device are covered under the policy, and the real-world/digital manners for which the device can be utilized.

According to some embodiments, the disclosed framework can provide an automated software management service (e.g., via cloud system 106, for example, as discussed supra) for warranty management and control of devices to streamline the process of managing warranty claims and ensure that customers receive prompt and efficient service. As provided herein, the disclosed framework can define warranty policies for devices, inclusive of what is covered, the duration and the conditions/exclusions of such policies.

In some embodiments, as discussed below, the framework can provide improved mechanisms for submitting warranty claims, which can be automated and generated via automatic event detection subject to the terms of an applied policy. In some embodiments, submission can be effectuated via an online portal, website or other electronic mechanisms (e.g., email, for example), which can be controlled and handled via the disclosed framework. In some embodiments, the framework may enable automated prompting to enable the submitting user to leverage known or to be known chatbot technology to assist in the claim's submission.

Similarly, in some embodiments, claims approval processing can be dynamically and automatically executed, which can be based on criteria of the policy and/or criteria of the event, as well as responses to prompts that provide chatbot responses.

In some embodiments, the disclosed warranty software service can enable automated notifications, which not only can be dynamically displayed within a provided user interface (UI), but can also adapt to the status of the policy and/or usage of the device by the subscribed user. In some embodiments, the UI can provide information related to, but not limited to, pricing structure of the policy, duration and/or terms of the policy, conditions/exclusions of the policy, eligibility (e.g., metrics, analytics, statistics, for example) of the device's usage under the policy, and/or determinations of submitted claims, and the like. In some embodiments, the information within the UI can be compiled and presented as a usage report, which can be interactive and enable the retrieval of supplemental or recommended information related to the device, the user, an event and/or a policy. Thus, the UI can enable a hub for policy management and/or claim status review during an underwriting process effectuated via the framework.

According to some embodiments, Steps 302-304 can be performed by identification module 202 of device management engine 200; Steps 306, 314 and 318 can be performed by determination module 204; Steps 308 and 312 can be performed by policy module 206; and Steps 310, 316 and 320 can be performed by control module 208.

According to some embodiments, Process 300 begins with Step 302 where engine 200 can detect a device's connection to a network. For example, upon a smartphone (e.g., UE 102) connecting to a location's Wi-Fi network. Accordingly, a location can be any type of definable geographical area that can have a network associated therewith, for example, a house, room, office, patio, and/or any other type of building, structure or area for which a network can be provided.

In some embodiments, Step 302 can involve identifying the device and/or a user associated with the device, and the corresponding information related to such device.

In Step 304, upon identifying the device's presence on the network, engine 200 can collect such identifying information related to the device and/or its connection. For example, engine 200 can collect information related to, but not limited to, device identifying information, device capability information, voice/data carrier information, IP address, applications installed or capable of being installed or executed on such device, channel within the network upon which the device is connected, and/or any, or some combination thereof. In some embodiments, the collection operation in Step 304 can enable engine 200 to determine usage and/or activity data of the device, which can include, but is not limited to, a location or movements of the device, network activities of the device, and the like, as discussed above. As such, as discussed above, such data can be stored in database 108 upon its identification and collection.

In Step 306, engine 200 can analyze the collected information about the device, and based on such analysis, determine an eligibility for the device (and/or the user, according to some embodiments). In some embodiments, such eligibility determination can be based on, but not limited to, a device type, device capabilities, user identifier(s), account(s) of the user, type of network capabilities, usage patterns/behavior of the device (and/or user), and the like, which can be identified and/or derived from the collected information in Step 304. In some embodiments, such analysis can be performed in real-time (or substantially real-time), as the data is received, and/or according to a time period or range of activities so as to understand the breadth of how the device is being utilized.

According to some embodiments, the analysis and determination of Step 306 can involve engine 200 implementing any type of known or to be known computational analysis technique, algorithm, mechanism or technology to analyze the monitored network data of the device.

In some embodiments, engine 200 may include a specific trained artificial intelligence/machine learning model (AI/ML), a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 200 may be configured to utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly-received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

Accordingly, in Step 306, engine 200 can determine and generate an eligibility data structure for the device. The data structure can include risk metrics for coverage as determined from the analysis of the collected data. In some embodiments, the data structure can be stored in database 108, and can include information that indicates, but is not limited to, statistics, metrics, predictions or other forms of computer-renderable data items that can indicate a degree, type and/or structure for which a policy can be enabled for the device.

Moreover, in some embodiments, it should be understood that that while the policy discussion herein is related to a device, it should not be construed as limiting, as a policy can be generated for a group or plurality of devices, for devices and/or users at a location, for a user or group of users, and/or a category or type of device, location or user, and the like, or some combination thereof.

For example, a policy can be generated for each device that connects to (at least a threshold amount of times within a time period) a network at a location. For example, for mom, dad, son and daughter, each of their devices can be subject to the processing by engine 200 of Process 300 discussed herein since they are residents of the home that is providing the network. However, should the daughter have a friend over periodically, since she is not a resident (e.g., does not connect or use the network the threshold satisfying number of times within a time period), her device would not be covered or considered for coverage.

In Step 308, based on the determined eligibility in Step 306, engine 200 can determine a policy for the device. In some embodiments, Step 308 can involve engine 200 parsing the eligibility data structure and extracting information related to types of activities as well as information corresponding to alleged risks in underwriting the device. In some embodiments, the analysis of the extracted information can be performed in a similar manner to the AI/ML model applications discussed above at least in relation to Step 306.

Accordingly, in Step 308, engine 200 can determine a policy for the device, which include information related to, but not limited to, a duration, policy provider, terms, conditions, exclusions and the like, or some combination thereof. In some embodiments, as discussed herein, the policy can monitor and/or manage activities of the device, which can include, but not be limited to, tracking physical, network and/or digital locations of the device (e.g., which websites it visits), and/or preventing particular activities based on such activities, and the like.

In some embodiments, Step 308 can involve the determination of a set of policies, which can be ranked or sequentially ordered according to their applicability (or similarity) to the eligibility determined in Step 306. As such, Step 308 can perform a similarity analysis between a determined or predetermined set of policies and/or criteria of policies, and determine which policy best matches (e.g., to a n ranking—for example, top 3) the eligibility for the device. In some embodiments, such similarity analysis can involve, but is not limited to, nearest neighbor approaches, feature vector translation and analysis and/or any other known or to be known similarity analysis AI/ML model/algorithm.

In some embodiments, the policy or policies determined in Step 308 can have determined or applied flexible pricing structures (or models) and/or subscriptions for which can determine how they can be applied to a device. Thus, the policy (or policies) identified/determined in Step 308 can represent a protection plan for the device, whereby levels of protections can be customized according to flexible subscriptions and/or pricing structures.

In Step 310, engine 200 can display information related to the policy determined in Step 310 within a user interface (UI). In some embodiments, the top n ranked policies can be displayed, which can enable selection by a user and/or mixing/matching of criteria among each policy so as to enable the flexible subscription and/or pricing mentioned above.

In some embodiments, the display of a policy can be provided via the UI in an interactive manner, in that terms, conditions and/or other information related to the policy, as well as the information utilized to derive the policy (e.g., the analyzed collected and determined information from Steps 304-306, discussed supra) can be depicted as interface objects (IOs) or as selectable content objects. As such, upon interaction with a displayed IO, supplemental content related to a policy and/or depicted information item can be retrieved and displayed so as to enable a user to make an informed policy decision.

For example, a policy can provide terms and, depicted within the UI, are IOs corresponding to usage metrics by the device. The user can select the usage metrics to view them as a graph so as to enable a better understanding of why certain terms are being offered and certain terms are not being offered, for example. In some embodiments, the usage metrics can enable viewing of content and/or activities that caused such metrics to be compiled. For example, the collected information from Step 304 can be displayed, and the determined eligibility information can also be displayed, which can cause the retrieval of additional content to provide a robust understanding of how/why certain policy terms are being offered.

In Step 312, the policy (or selected policy) can be applied to the device. In some embodiments, the selection of a policy can occur automatically (e.g., selected the determined or top rated policy), and in some embodiments, the policy can be identified and selected via interaction by a user, as discussed above.

In some embodiments, the application of the policy can cause a policy data structure (or file) to be stored in database 108, which can be in relation to an account of the device/user. In some embodiments, the policy data structure can be compiled as an executable file that monitors how the device operates on networks and/or tracks its physical location and movements (e.g., compile sensor data from the device—for example, track the gyroscope data to determine how the device is being handled). Accordingly, in some embodiments, engine 200 can enable network data and/or usage analytics of the device to be tracked and/or mapped i) from cloud system 106 and/or ii) at the device level via a local-client policy manager effectuated via engine 200's implementation of the policy data structure (or file).

In Step 314, engine 200 can determine (or detect) an event related to a warranty claim under the applied policy. In some embodiments, as discussed above, device usage (e.g., both real-world activities and digital activities) can be monitored, and such data can be analyzed. In some embodiments, such monitoring can be performed, but not limited to, continuously, periodically according to a time period (e.g., every 30 minutes, for example), upon request (by a user or policy provider, for example), upon detection of a type of event (e.g., movement data at or above a threshold level, malware detection, certain websites being visited, and the like, or some combination thereof), and the like, or some combination thereof.

In some embodiments, the event corresponds to an action (or non-action) that corresponds or triggers a term or condition of the applied policy. For example, it is determined that the user's phone was submerged in water (e.g., dropped the phone in the bathtub, for example); as such, engine 200 can determine that a clause in the policy governing a malfunctioning device has been triggered, which can be effectuated via engine 200 compiling the event data, and parsing the policy data structure so as to mine (and extract) for corresponding criteria located therein.

Upon detection of such event, engine 200 can perform Step 316 where a claim can be automatically generated, filled out and submitted. In some embodiments, such claim submission can involve, but is not limited to, accessing an online portal, network location or other type of network resource for which a policy provider's claim submission process can be effectuated. In some embodiments, Step 316 can involve engine 200 compiling an electronic document which can be electronically communicated to a policy provider's network address (e.g., send an email to a policy submission address, for example). In some embodiments, the generation of the policy can include the compilation and automatic entry of information related to, but not limited to, a device and/or user identifier (ID), event information (e.g., date, time and specific details of the activity that caused and/or were involved in the event), policy ID, and/or any other types of information for which is required for an insurance/warranty claim.

Thus, Step 316 can result in the generated and completed claim for the event being submitted for review. In some embodiments, information related to the clam and its submission can be stored in database 108.

In Step 318, engine 200 can effectuate, cause and/or perform analysis of the claim, and enable the automatic determination of the appropriateness of the claim (e.g., whether the event related to the device is covered by the policy). In some embodiments, Step 318 can involve the claim being analyzed via engine 200's embodiment of a warranty software service, as discussed above. In some embodiments, Step 318's determination can be performed in a similar manner as discussed above via the AI/ML analysis/determinations in Step 306.

And, in Step 320, engine 200 displays within the UI information related to the determination in Step 318. Accordingly, in some embodiments, a usage report and/or event report can be generated and/or updated that provides a detailed reasoning as to what the claim entailed, the event details, the determination as to whether the claim was approved or denied, and the reasoning, as supported by information from the policy, and the like. Such information can be displayed as IOs, as discussed above at least in relation to Step 310, such that additional and/or supplemental information related to the warranty claim decision can be further researched and understood by the user of the device.

FIG. 6 is a schematic diagram illustrating a client device showing an example embodiment of a client device that may be used within the present disclosure. Client device 600 may include many more or less components than those shown in FIG. 6. However, the components shown are sufficient to disclose an illustrative embodiment for implementing the present disclosure. Client device 600 may represent, for example, UE 102 discussed above at least in relation to FIG. 1.

As shown in the figure, in some embodiments, Client device 600 includes a processing unit (CPU) 622 in communication with a mass memory 630 via a bus 624. Client device 600 also includes a power supply 626, one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal or electromagnetic sensors 666. Device 600 can include one camera/sensor 666, or a plurality of cameras/sensors 666, as understood by those of skill in the art. Power supply 626 provides power to Client device 600.

Client device 600 may optionally communicate with a base station (not shown), or directly with another computing device. In some embodiments, network interface 650 is sometimes known as a transceiver, transceiving device, or network interface card (NIC).

Audio interface 652 is arranged to produce and receive audio signals such as the sound of a human voice in some embodiments. Display 654 may be a liquid crystal display (LCD), gas plasma, light emitting diode (LED), or any other type of display used with a computing device. Display 654 may also include a touch sensitive screen arranged to receive input from an object such as a stylus or a digit from a human hand.

Keypad 656 may include any input device arranged to receive input from a user. Illuminator 658 may provide a status indication and/or provide light.

Client device 600 also includes input/output interface 660 for communicating with external. Input/output interface 660 can utilize one or more communication technologies, such as USB, infrared, Bluetooth™, or the like in some embodiments. Haptic interface 662 is arranged to provide tactile feedback to a user of the client device.

Optional GPS transceiver 664 can determine the physical coordinates of Client device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS or the like, to further determine the physical location of client device 600 on the surface of the Earth. In one embodiment, however, Client device may through other components, provide other information that may be employed to determine a physical location of the device, including for example, a MAC address, Internet Protocol (IP) address, or the like.

Mass memory 630 includes a RAM 632, a ROM 634, and other storage means. Mass memory 630 illustrates another example of computer storage media for storage of information such as computer readable instructions, data structures, program modules or other data. Mass memory 630 stores a basic input/output system (“BIOS”) 640 for controlling low-level operation of Client device 600. The mass memory also stores an operating system 641 for controlling the operation of Client device 600.

Memory 630 further includes one or more data stores, which can be utilized by Client device 600 to store, among other things, applications 642 and/or other information or data. For example, data stores may be employed to store information that describes various capabilities of Client device 600. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 600.

Applications 642 may include computer executable instructions which, when executed by Client device 600, transmit, receive, and/or otherwise process audio, video, images, and enable telecommunication with a server and/or another user of another client device. Applications 642 may further include a client that is configured to send, to receive, and/or to otherwise process gaming, goods/services and/or other forms of data, messages and content hosted and provided by the platform associated with engine 200 and its affiliates.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, API, instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
collecting, by a device, information related to at least one of network and usage data of a user device, the user device being connected to a network associated with a location;
analyzing, by the device, the information, and determining an eligibility of the user device, the device eligibility comprising information related to determined risk metrics for the user device;
analyzing, by the device, the device eligibility, and determining a policy for the user device, the policy comprising executable information for managing the user device based on the determined risk metrics, the executable information criteria defined by the policy;
determining, by the device, an event, the event corresponding to activity involving the user device that corresponds to the criteria of the policy;
automatically generating, by the device, a claim submission comprising information related to at least the activity of the event; and
electronically submitting, by the device, over the network to an online network resource, without user input, the generated claim submission.

2. The method of claim 1, further comprising:
analyzing the generated claim submission; and
determining whether to approve or deny the claim submission for the event.

3. The method of claim 2, further comprising:
causing display, on a display associated with the user device, an event report within a displayed user interface (UI), the event report comprising interactive information related to the approval or denial determination.

4. The method of claim 1, further comprising:
detecting an initial connection by the user device to the network, wherein the collection of the information is based on the initial connection, wherein the connection corresponds to a threshold satisfying amount of connections by the user device for the location.

5. The method of claim 1, further comprising:
causing display, on a display associated with the user device, a user interface (UI), the UI comprising a visibly display of a usage report for the user device based on the analyzed information and the determined policy, wherein the usage report comprises interactive functionality for exploring supplemental information related to the analyzed information and the determined policy.

6. The method of claim 1, further comprising:
monitoring, based on the executable information of the policy, usage data of the user device;
analyzing the usage data; and
determining, based on the analysis of the usage data, the event.

7. The method of claim 6, wherein the event corresponds to at least one of real-world activity involving the user device and digital activity caused by the user device.

8. The method of claim 1, wherein the collected information comprises information related to the user device and activities of at least one user of the user device.

9. The method of claim 1, wherein the user device comprises a plurality of user devices connected to the network at the location, wherein the policy is determined for the plurality of user devices.

10. The method of claim 1, wherein the network is a Wi-Fi network, whereby the device is associated with a cloud system.

11. A device comprising:
a processor configured to:
collect information related to at least one of network and usage data of a user device, the user device being connected to a network associated with a location;
analyze the information, and determine an eligibility of the user device, the device eligibility comprising information related to determined risk metrics for the user device;
analyze the device eligibility, and determine a policy for the user device, the policy comprising executable information for managing the user device based on the determined risk metrics, the executable information criteria defined by the policy;
determine an event, the event corresponding to activity involving the user device that corresponds to the criteria of the policy;
automatically generate a claim submission comprising information related to at least the activity of the event; and
electronically submit, over the network to an online network resource, without user input, the generated claim submission.

12. The device of claim 11, wherein the processor is further configured to:
analyze the generated claim submission;
determine whether to approve or deny the claim submission for the event; and
cause display, on a display associated with the user device, an event report within a displayed user interface (UI), the event report comprising interactive information related to the approval or denial determination.

13. The device of claim 11, wherein the processor is further configured to:
detect an initial connection by the user device to the network, wherein the collection of the information is based on the initial connection, wherein the connection corresponds to a threshold satisfying amount of connections by the user device for the location.

14. The device of claim 11, wherein the processor is further configured to:
cause display, on a display associated with the user device, a user interface (UI), the UI comprising a visibly display of a usage report for the user device based on the analyzed information and the determined policy, wherein the usage report comprises interactive functionality for exploring supplemental information related to the analyzed information and the determined policy.

15. The device of claim 11, wherein the processor is further configured to:
monitoring, based on the executable information of the policy, usage data of the user device;
analyze the usage data; and
determine, based on the analysis of the usage data, the event, wherein the event corresponds to at least one of real-world activity involving the user device and digital activity caused by the user device.

16. A non-transitory computer-readable storage medium tangibly encoded with computer-executable instructions that when executed by a device, perform a method comprising:
collecting, by the device, information related to at least one of network and usage data of a user device, the user device being connected to a network associated with a location;
analyzing, by the device, the information, and determining an eligibility of the user device, the device eligibility comprising information related to determined risk metrics for the user device;
analyzing, by the device, the device eligibility, and determining a policy for the user device, the policy comprising executable information for managing the user device based on the determined risk metrics, the executable information criteria defined by the policy;
determining, by the device, an event, the event corresponding to activity involving the user device that corresponds to the criteria of the policy;
automatically generating, by the device, a claim submission comprising information related to at least the activity of the event; and
electronically submitting, by the device, over the network to an online network resource, without user input, the generated claim submission.

17. The non-transitory computer-readable storage medium of claim 16, further comprising:
analyzing the generated claim submission;
determining whether to approve or deny the claim submission for the event; and
causing display, on a display associated with the user device, an event report within a displayed user interface (UI), the event report comprising interactive information related to the approval or denial determination.

18. The non-transitory computer-readable storage medium of claim 16, further comprising:
detecting an initial connection by the user device to the network, wherein the collection of the information is based on the initial connection, wherein the connection corresponds to a threshold satisfying amount of connections by the user device for the location.

19. The non-transitory computer-readable storage medium of claim 16, further comprising:
causing display, on a display associated with the user device, a user interface (UI), the UI comprising a visibly display of a usage report for the user device based on the analyzed information and the determined policy, wherein the usage report comprises interactive functionality for exploring supplemental information related to the analyzed information and the determined policy.

20. The non-transitory computer-readable storage medium of claim 16, further comprising:
monitoring, based on the executable information of the policy, usage data of the user device;
analyzing the usage data; and
determining, based on the analysis of the usage data, the event, wherein the event corresponds to at least one of real-world activity involving the user device and digital activity caused by the user device.
